(19) United States
(12) Patent Application Publication
(10) Pub. No.: US 2025/0336211 A1
(43) Pub. Date: Oct. 30, 2025

(54) METHODS, SYSTEMS, AND STORAGE MEDIA FOR SMART CITY EMERGENCY SUPERVISION BASED ON IOT LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Rui RU, Chengdu (CN); Siwei ZENG, Chengdu (CN); Yongzeng LIANG, Chengdu (CN)

(73) Assignee: CHENGDU QINCHUAN IOT TECHNOLOGY CO., LTD., Chengdu (CN)

(21) Appl. No.: 19/262,039

(22) Filed: Jul. 7, 2025

(30) Foreign Application Priority Data
May 14, 2025 (CN) 202510616074.6

(51) Int. Cl. G06V 20/52; G06V 20/56; G16Y 40/50

(52) U.S. Cl. CPC G06V 20/52; G06V 20/56; G16Y 40/50

(57) ABSTRACT

The present disclosure relates to a method, a system, and a storage medium for smart city emergency supervision based on an IoT large model, the method including: in response to receiving an emergency management request from a sub-platform, determining a data retrieval prioritization for the emergency management request based on a first emergency level of the emergency management request; retrieving emergency management data corresponding to the emergency management request from a database based on the data retrieval prioritization.

### CROSS-REFERENCE TO RELATED APPLICATIONS

This application claims priority to the Chinese Patent Application No. 202510616074.6, filed on May 14, 2025, the contents of which are hereby incorporated by reference.

### TECHNICAL FIELD

The present disclosure relates to the field of smart city, and particularly relates to a method, a system, and a storage medium for smart city emergency supervision based on an Internet of Things (IoT) large model.

### BACKGROUND

A traditional emergency management system often suffers from low data collection efficiency, slow response time, and irrational resource scheduling, making it difficult to meet the demands of modern cities for quick and precise handling of emergency events. In particular, when facing an emergency event, how to efficiently integrate multi-source data, dynamically adjust emergency resources, and realize intelligent decision-making support has become a key issue to be addressed by a system for smart city emergency supervision.

Therefore, it is expected that a system for smart city emergency supervision based on an IoT large model will be provided to solve the problems of uniformity and blind spots in the traditional management mode. The system will integrate a plurality of data sources, realize dynamic scheduling and decision-making support through intelligent algorithms, improve timeliness and effectiveness of emergency supervision, ensure efficient responses to emergency events in a plurality of environments, and promote the construction and development of the smart city.

### SUMMARY

Embodiments of the present disclosure provide a method for smart city emergency supervision based on an IoT large model. The method is executed by an emergency supervision management platform, the method including: in response to receiving an emergency management request from a sub-platform, determining a data retrieval prioritization for the emergency management request based on a first emergency level of the emergency management request; retrieving emergency management data corresponding to the emergency management request from a database based on the data retrieval prioritization, including: retrieving a plurality of pieces of emergency management data corresponding to the emergency management request; retrieving, based on the plurality of pieces of emergency management data and a second emergency level of each piece of emergency management data of the plurality of pieces of emergency management data, a preset processing model corresponding to the each piece of emergency management data from a data processing model library; processing the each piece of emergency management data using a corresponding preset processing model to generate processed emergency management data; sending the processed emergency management data to the sub-platform.

In some embodiments, the method further includes: within a preset period: obtaining a plurality of second emergency levels of a plurality of pieces of emergency management data across a plurality of geographic regions; for each geographic region of the plurality of geographic regions: determining collection parameters for different pieces of emergency management data within the geographic region based on the plurality of second emergency levels, the collection parameters including a patrol time and/or a patrol frequency of the emergency vehicle for the different pieces of emergency management data, and a shooting angle and/or a shooting frequency of a camera disposed on the emergency vehicle at a patrol point; generating a patrol instruction based on the collection parameters and sending the patrol instruction to an emergency supervision object platform to control the emergency vehicle located in the geographic region to patrol within the geographic region according to the patrol time and/or the patrol frequency, and to control the camera at the patrol point to capture images according to the shooting angle and/or the shooting frequency to acquire a corresponding piece of emergency management data; during a patrol by an emergency vehicle, controlling a built-in terminal in the emergency vehicle to detect an image captured at a patrol point; and receiving a warning instruction returned by the built-in terminal and displaying the warning instruction on a display device.

Embodiments of the present disclosure provide a system for smart city emergency supervision based on an IoT large model. The system includes an emergency supervision management platform, an emergency supervision sensing network platform, and an emergency supervision object platform. The emergency supervision management platform is communicatively connected to the emergency supervision object platform via the emergency supervision sensing network platform. The emergency supervision management platform includes sub-platforms and a data center. The sub-platforms include at least one of an emergency prevention sub-platform, an emergency monitoring sub-platform, a risk prevention sub-platform, and an emergency response sub-platform. The data center includes a database, a data processing model library, and a computing unit. The emergency supervision management platform is configured to execute the method for smart city emergency supervision based on the IoT large model.

Embodiments of the present disclosure provide a non-transitory computer-readable storage medium, the storage medium storing computer instructions, when a computer reads the computer instructions in the storage medium, the computer executes the method for smart city emergency supervision based on the IoT large model.

### BRIEF DESCRIPTION OF THE DRAWINGS

The present disclosure will be further illustrated with reference to a plurality of exemplary embodiments, described in detail using the accompanying drawings. These embodiments are not limiting, and in these embodiments, the same numbering denotes the same structure, wherein:

FIG. 1 is a schematic diagram of a system platform of a system for smart city emergency supervision based on an IoT large model according to some embodiments of the present disclosure;

FIG. 2 is an exemplary flowchart illustrating a method for smart city emergency supervision based on an IoT large model according to some embodiments of the present disclosure;

FIG. 3 is an exemplary flowchart illustrating a process for retrieving emergency management data corresponding to an emergency management request from a database according to some embodiments of the present disclosure;

FIG. 4 is an exemplary flowchart illustrating a process for determining a first emergency level of an emergency management request according to some embodiments of the present disclosure; and

FIG. 5 is an exemplary flowchart illustrating a process for controlling sensors in a geographic region to upload data according to a data upload feature according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and it is possible for those skilled in the art to apply the present disclosure to other similar scenarios based on the accompanying drawings without creative labor. Unless obviously obtained from the context or the context illustrates otherwise, the same numeral in the drawings refers to the same structure or operation.

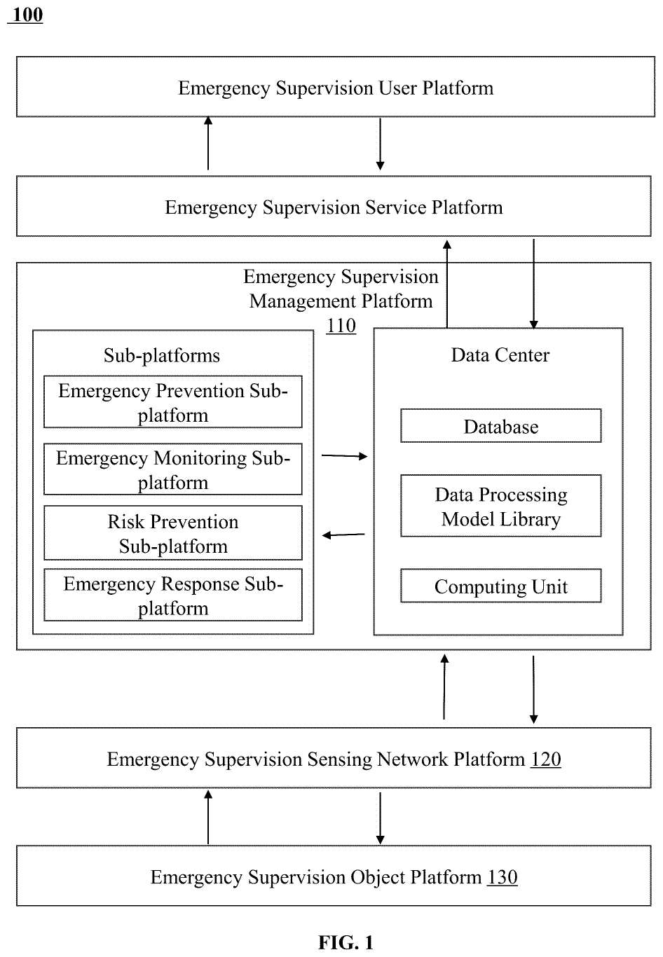

FIG. 1 is a schematic diagram of a system platform of a system for smart city emergency supervision based on an IoT large model according to some embodiments of the present disclosure.

In some embodiments, as shown in FIG. 1, a system for smart city emergency supervision based on an IoT large model 100 may include an emergency supervision management platform 110, an emergency supervision sensing network platform 120, and an emergency supervision object platform 130.

The emergency supervision management platform 110 refers to a digital monitoring and management platform for supervising emergency events throughout an entire region. The emergency event refers to a sudden, destructive, and harmful event, e.g., a natural disaster, an accidental disaster, a public health event, a social security event, etc.

In some embodiments, the emergency supervision management platform 110 may be implemented on a processor and/or a server. The processor and/or the server may process data and/or information obtained from other platforms. The processor and/or the server may execute program instructions based on the data, information, and/or processing results to perform one or more functions described in the present disclosure.

The emergency supervision sensing network platform 120 refers to a platform configured to sense and communicate information for smart city emergency supervision, and to enable two-way data transmission between the emergency supervision management platform 110 and the emergency supervision object platform 130. For example, the emergency supervision sensing network platform may include a communication device, a server, a plurality of types of gateway devices, or the like.

The emergency supervision object platform 130 refers to an information processing platform for the safety supervision of a plurality of supervision objects related to emergency management. The supervision objects may include a chemical plant producing flammable and explosive products, a transportation hub, a public venue, or the like. The emergency supervision object platform 130 may include a plurality of monitoring, sensing, and interaction devices, e.g., cameras, fire alarms, hazardous gas leak monitors, environmental monitoring sensors, or the like.

In some embodiments, the emergency supervision management platform 110 is communicatively connected to the emergency supervision object platform 130 through the emergency supervision sensing network platform 120.

In some embodiments, the emergency supervision management platform 110 includes a sub-platform and a data center.

In some embodiments, the sub-platform includes at least one of an emergency prevention sub-platform, an emergency monitoring sub-platform, a risk prevention sub-platform, and an emergency response sub-platform.

The emergency prevention sub-platform refers to a management platform configured to assess and prevent emergency events.

The emergency monitoring sub-platform refers to a platform configured to monitor, collect, and analyze emergency event data.

The risk prevention sub-platform refers to a platform configured to identify potential risks, assess risk levels, and implement risk reduction strategies.

The emergency response sub-platform refers to a platform configured to coordinate, dispatch, and execute emergency response plans after the occurrence of an emergency event.

In some embodiments, the data center includes a database, a data processing model library, and a computing unit.

The database is configured to collect, store, and manage a plurality of pieces of emergency management data. For example, the database may include MySQL, PostgreSQL, Influx DB, Prometheus, etc.

The data processing model library refers to a collection of data processing models configured to process the emergency management data.

The computing unit refers to a functional module configured to perform arithmetic, logic, and other instruction operations. The computing unit may include, but is not limited to, a central processing unit (CPU), or the like.

In some embodiments, the system for smart city emergency supervision based on the IoT large model further includes an emergency supervision user platform and an emergency supervision service platform.

The emergency supervision user platform refers to an interactive platform for emergency managers and the public. In some embodiments, the emergency supervision user platform may include at least one user interaction device. For example, the emergency supervision user platform may include a cell phone, a computer, or the like.

The emergency supervision service platform refers to a platform for emergency supervision services. In some embodiments, the emergency supervision service platform may be configured as a server and may exchange data with the emergency supervision user platform and the emergency supervision management platform. For example, after discovering an emergency event, the public uses the emergency supervision user platform to report a situation of the emergency event to the emergency supervision service platform. The emergency supervision service platform then reports the relevant event and the impact assessment of the emergency event to the emergency supervision management platform to facilitate response and decision-making by the management department.

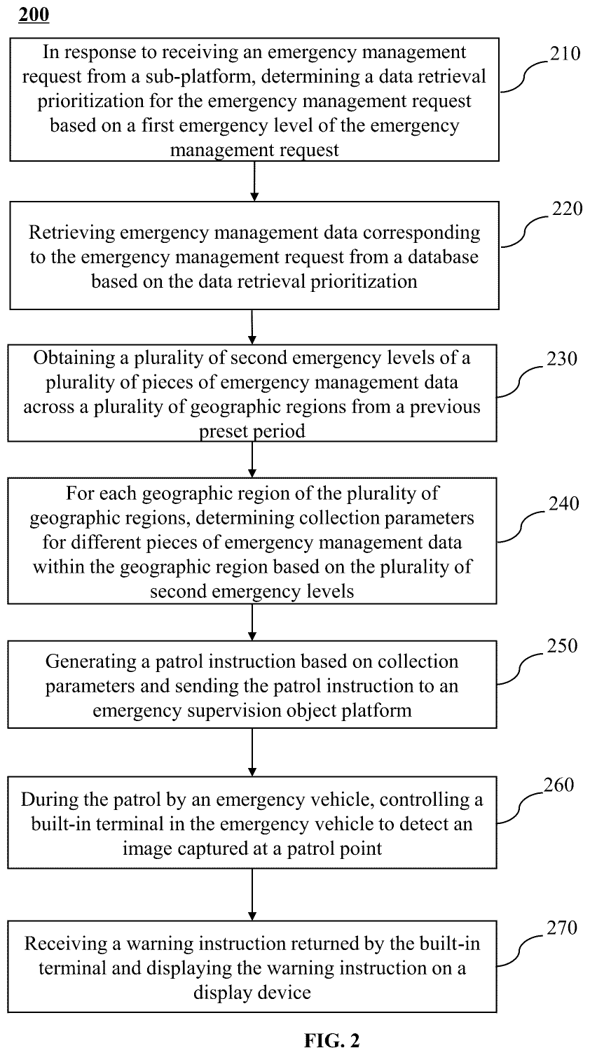

FIG. 2 is an exemplary flowchart illustrating a method for smart city emergency supervision based on an IoT large model according to some embodiments of the present disclosure. As shown in FIG. 2, process 200 includes the following steps. In some embodiments, the process 200 may be performed on the emergency supervision management platform.

Step 210, in response to receiving an emergency management request from a sub-platform, determining a data retrieval prioritization for the emergency management request based on a first emergency level of the emergency management request. In some embodiments, the step 210 is performed by a data center.

The emergency management request refers to an instruction sent by a sub-platform to retrieve one or more pieces of emergency management data. For example, the emergency management request refers to an instruction sent by an emergency prevention sub-platform to retrieve the emergency management data related to accidental disaster prevention.

The first emergency level refers to an important level of the emergency management request. The first emergency level may include a plurality of levels. Different emergency management requests correspond to different important levels of the first emergency level.

In some embodiments, the first emergency level of the emergency management request may be preset by a technician or a staff.

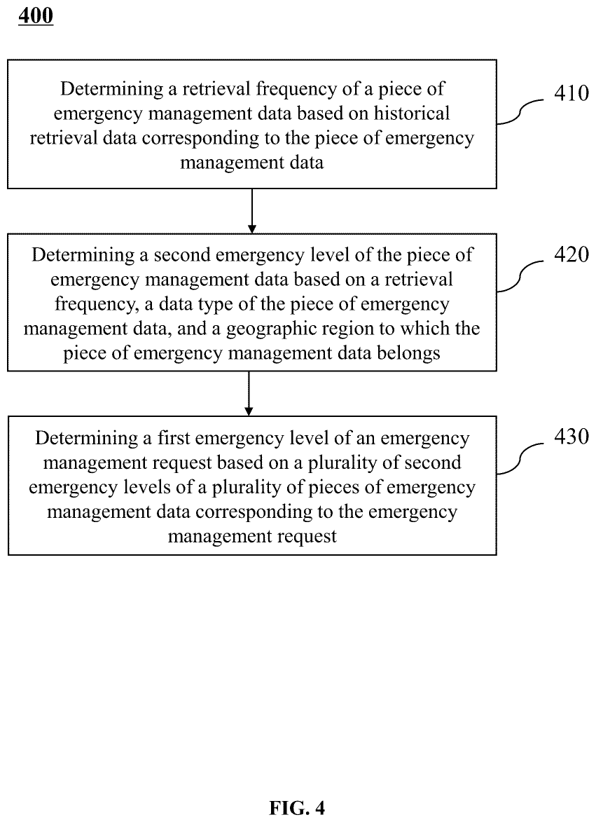

In some embodiments, the first emergency level of the emergency management request may further be determined based on one or more second emergency levels of the one or more pieces of emergency management data corresponding to the emergency management request. More details regarding determining the first emergency level of the emergency management request may be found in FIG. 4.

The data retrieval prioritization refers to an order for retrieving the one or more pieces of emergency management data corresponding to a plurality of emergency management requests.

In some embodiments, the data center sorts the plurality of emergency management requests according to the plurality of first emergency levels. For example, the data retrieval prioritization of the emergency management request is determined in descending order of important levels corresponding to the first emergency level.

Step 220, retrieving the emergency management data corresponding to the emergency management request from a database based on the data retrieval prioritization. In some embodiments, the step 220 is performed by the data center.

The emergency management data refers to a plurality of types of monitoring data required for emergency management. Merely by way of example, the emergency management data may include at least one of ambient temperature, ambient humidity, wind speed, detection of open fire in an environment, concentration of combustible gas/toxic gas, a crowd size, quantity of flammable and explosive articles, duration of gas outage, or a combination thereof.

The emergency management data is tagged with an electronic tag during transmission. The electronic tag includes a data type and a geographic region to which the emergency management data belongs. The electronic tag may further include a unique number of a device that collects the emergency management data, such as a unique number of a sensor, a camera, or the like. The data type may include text, image, video, audio, etc. The geographic region to which the emergency management data belongs is a geographic region where a device that collects the emergency management data is located. The geographic region may include an administrative region, a grid region, etc. The device for collecting the emergency management data may include a plurality of types of sensors, cameras, etc.

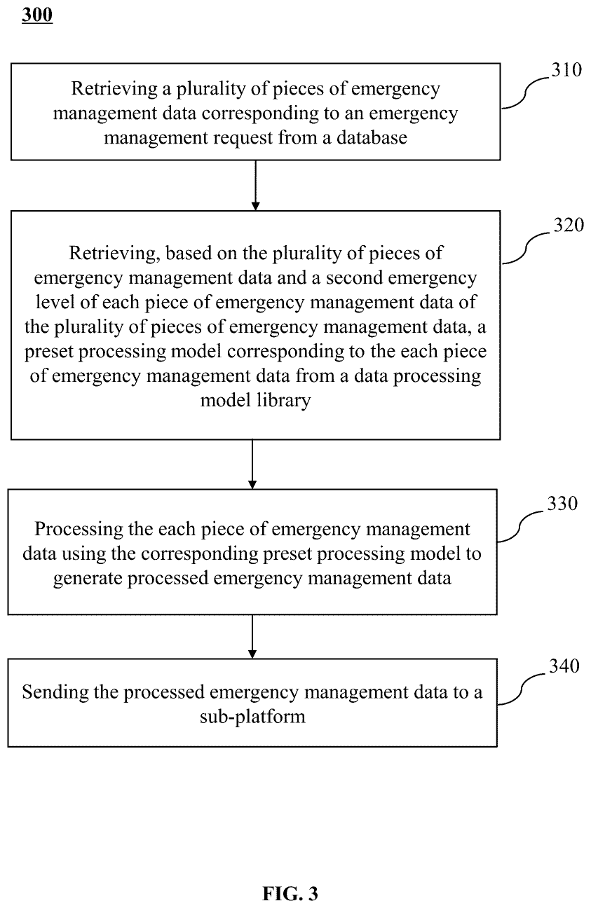

In some embodiments, the data center retrieves, based on the data retrieval prioritization, the one or more pieces of emergency management data corresponding to the emergency management request directly from the database. In some embodiments, the data center may further process the emergency management data and send processed emergency management data to a corresponding sub-platform. More details may be found in FIG. 3 and the related descriptions.

Step 230, obtaining a plurality of second emergency levels of a plurality of pieces of emergency management data across a plurality of geographic regions in a previous preset period. In some embodiments, the step 230 is performed by an emergency supervision management platform.

The second emergency level refers to an important level of the emergency management data. The pieces of emergency management data with different second emergency levels correspond to different important levels.

In some embodiments, the second emergency level of the emergency management data may be preset by a technician. In some embodiments, the second emergency level of the emergency management data may further be determined based on a retrieval frequency during the previous preset period, the data type of the emergency management data, and the geographic region to which the emergency management data belongs, and more details may be found in FIG. 4 and the related descriptions.

A preset period refers to a period for determining and executing a data collection frequency. In some embodiments, the preset period is set by a technician or staff based on experience. For example, the preset period may be set to a day, a week, a month, etc.

The geographic region refers to a geographic region where a device that collects the emergency management data is located. The geographic region may be an administrative region, or the like.

In some embodiments, the second emergency level of the same type of the emergency management data corresponding to the plurality of geographic regions may be different. Merely by way of example, for a type of the emergency management data such as the crowd size, the second emergency level of the emergency management data in a central region is higher than the second emergency level of the emergency management data in a non-central region.

Step 240, for each geographic region of the plurality of geographic regions, determining collection parameters for different pieces of emergency management data within the geographic region based on the plurality of second emergency levels. In some embodiments, the step 240 is performed by the emergency supervision management platform.

The collection parameters include a patrol time and/or a patrol frequency of an emergency vehicle for the different pieces of emergency management data, and a shooting angle and/or a shooting frequency of a camera disposed on the emergency vehicle at a patrol point.

The emergency vehicle refers to a vehicle for collecting the emergency management data and/or handling an emergency incident (also referred to as an emergency event). In some embodiments, the emergency vehicle may include an unmanned vehicle, a manned vehicle, an unmanned aerial vehicle, etc. In some embodiments, the emergency vehicle may include a fire truck, a medical vehicle, an emergency rescue vehicle, a power supply vehicle, a skid-mounted refueling station, etc.

The patrol time refers to one or more time points for the emergency vehicle to start a patrol during the preset period, e.g., at 10:00 and/or 16:00 daily. The patrol frequency refers to a frequency and interval for the emergency vehicle to patrol along a planned route during the preset period, e.g., five patrols daily at two-hour intervals.

The patrol point refers to a location on a planned route where the emergency vehicle collects data, e.g., a critical area requiring attention.

The shooting angle includes a camera angle in horizontal and vertical directions, a horizontal movement angle, a vertical movement angle, etc. The shooting frequency refers to an image capture frame rate, e.g., 25 fps, etc.

In some embodiments, the collection parameters for the different pieces of emergency management data in the geographic region may be determined based on an average value of the second emergency levels of corresponding emergency management data in the previous preset period and a first preset table. The first preset table includes the collection parameters corresponding to each piece of emergency management data at different average values of the second emergency levels. The first preset table may be set by a technician based on experience.

Step 250, generating a patrol instruction based on the collection parameters and sending the patrol instruction to an emergency supervision object platform. In some embodiments, the step 250 is performed by the emergency supervision management platform.

The patrol instruction is sent to the emergency supervision object platform to control the emergency vehicle located in the geographic region to patrol according to the patrol time and/or the patrol frequency within the geographic region, and to control a camera at the patrol point to capture images according to the shooting angle and/or the shooting frequency for collecting the corresponding emergency management data.

The patrol instruction refers to an instruction including the patrol time and/or the patrol frequency, and the shooting angle and/or the shooting frequency. For example, the patrol instruction directly controls the patrol vehicle and the camera in the form of computer instruction.

Step 260, during a patrol by the emergency vehicle, controlling a built-in terminal in the emergency vehicle to detect the image captured at the patrol point. In some embodiments, the step 260 is performed by the emergency supervision management platform.

The built-in terminal refers to a processor for image detection, e.g., a graphics processing unit or a central processing unit.

In some embodiments, after obtaining image data, the graphics processing unit of the built-in terminal outputs a detection result indicating whether the image is an accident image. When the output detection result indicates that the image is the accident image, the built-in terminal determines that an accident occurrence is detected.

In some embodiments, after detecting an accident occurrence, the built-in terminal generates a warning instruction and sends the warning instruction to the emergency supervision management platform.

Step 270, receiving the warning instruction returned by the built-in terminal and displaying the warning instruction on a display device. In some embodiments, the step 270 is performed by the emergency supervision management platform.

The warning instruction includes an accident type, an occurrence location, and an occurrence time. The accident type may include detecting an open fire point, a crowd density exceeding a threshold, etc.

In some embodiments, the emergency supervision management platform sends the received warning instruction to the display device for display. The display device includes a display device associated with a user, such as an early warning center display screen, a mobile phone terminal, a computer terminal, or a combination thereof.

Setting the first emergency level for the emergency management request, allows the emergency management request to be processed sequentially according to the order of the first emergency level under conditions of request congestion, such as when a plurality of emergency management requests are waiting for processing, thereby enabling the emergency management request with a high emergency level to be prioritized. Further, determining the collection parameters corresponding to the geographic regions based on the second emergency levels of the plurality of pieces of emergency management data in the plurality of geographic regions, and generating the patrol instruction, ensures effective patrolling by the emergency vehicles in the different geographic regions.

FIG. 3 is an exemplary flowchart illustrating a process for retrieving emergency management data corresponding to an emergency management request from a database according to some embodiments of the present disclosure. As shown in FIG. 3, process 300 includes the following steps. In some embodiments, the process 300 may be performed by the data center.

Step 310, retrieving a plurality of pieces of emergency management data corresponding to an emergency management request from a database.

In some embodiments, the data center retrieves the plurality of pieces of emergency management data corresponding to the emergency management request from the database based on a data retrieval prioritization of the emergency management request.

Step 320, retrieving, based on the plurality of pieces of emergency management data and a second emergency level of each piece of emergency management data of the plurality of pieces of emergency management data, a preset processing model corresponding to the each piece of emergency management data from a data processing model library.

The data processing model library refers to a library that stores the plurality of preset processing models with varying output precisions and parameter scales.

The output precision refers to the accuracy degree of a model output result. Taking the emergency management data of a crowd size as an example, the different output precisions of the corresponding data processing model (also referred to as the preset processing model) may include retaining one decimal place, two decimal places, etc.

The parameter scale refers to a count of input parameters to a model and/or the precision of the input parameters. When the emergency management data includes image-based emergency management data, the input parameter includes a precision of the image, such as a resolution of the image.

In some embodiments, the data center sorts the plurality pieces of emergency management data based on the second emergency level of the each piece of emergency management data, from high to low, to obtain a sorted sequence, and retrieves the preset processing model corresponding to the each piece of emergency management data sequentially according to the sorted sequence.

In some embodiments, the preset processing model corresponding to the piece of emergency management data varies based on a range of the second emergency level of the piece of emergency management data. The different preset processing models have different output precisions and/or parameter scales.

In some embodiments, the higher the second emergency level is, the smaller the output precision and/or the parameter scale of the preset processing model is.

The data center may select the corresponding preset processing model according to the range into which the second emergency level of the piece of emergency management data falls.

The preset processing model refers to a model for processing the emergency management data. The preset processing model may be a machine learning model, e.g., a neural network (NN) model. An input of the preset processing model is the emergency management data. The emergency management data may include text, an image, etc. An output of the preset processing model is information required for the emergency management request. Merely by way of example, when the inputted emergency management data is an image about the crowd size, the preset processing model processes the image and outputs a result about the crowd size.

In some embodiments, the data center may obtain a plurality of training samples, each training sample including sample emergency management data and a corresponding label, the label referring to information required for a sample emergency management request corresponding to the sample emergency management data, e.g., the crowd size. The sample emergency management data in the training samples may be sourced from historical emergency management data, and the corresponding label may be manual labeling information for the historical emergency management data.

In some embodiments, the data center may input the sample emergency management data of the training sample into an initial preset processing model to obtain a model prediction output for the training sample; obtain a value of a loss function by substituting the model prediction output and a label of the training sample into a predefined loss function formula; update model parameters in the initial preset processing model through backpropagation based on the value of the loss function; and stop the iteration and obtain the trained preset processing model when an iteration termination condition is satisfied. The update may be performed in a plurality of manners such as a gradient descent manner.

In some embodiments, the data center may perform an incremental training on the plurality of preset processing models in the data processing model library based on the emergency management data retrieved during a preset period. A training sequence for the plurality of preset processing models is determined based on a plurality of emergency management requests corresponding to the plurality of preset processing models during the preset period.

In some embodiments, the data center may extract a plurality of pieces of emergency management data that have been retrieved during the preset period and the corresponding processed emergency management data. The processed emergency management data may be directly used as the label corresponding to the plurality of pieces of emergency management data, or may be manually corrected and then used as the label corresponding to the plurality of pieces of emergency management data. The data center may use the plurality of pieces of emergency management data and the corresponding labels as incremental training samples for training. The training process is similar to the model training process described above, and therefore will not be reiterated herein.

Merely by way of example, a preset processing model may have processed a plurality of pieces of emergency management data corresponding to the plurality of emergency management requests in a preset period, and the plurality of emergency management requests are the emergency management requests corresponding to the preset processing model during the preset period. For each preset processing model, the data center may determine a training sequence for the preset processing model based on an average value of the first emergency levels of the emergency management requests corresponding to the preset processing model. For example, the higher the average value of the first emergency levels is, the higher the training priority of the corresponding preset processing model is.

By determining an incremental training sequence for the different preset processing models according to emergency management requests, the data processing efficiency of the system is improved while enhancing the output effect of the preset processing models.

Step 330, processing the each piece of emergency management data using the corresponding preset processing model to generate the processed emergency management data.

For more details regarding the preset processing model, please refer to step 320.

Step 340, sending the processed emergency management data to the sub-platform.

In some embodiments, the data center sends the processed emergency management data to the sub-platform that issued the emergency management request corresponding to the emergency management data. The corresponding sub-platform may then make further preparations for the corresponding emergency management based on the received data information, for example, deploy a corresponding number of crowd evacuation devices mobilizing evacuation devices based on the accident crowd size.

Processing the emergency management data according to a prioritization of the second emergency levels of the plurality of pieces of emergency management data enables the emergency management data with high emergency levels to be processed and results acquired preferentially, thereby improving emergency management efficiency.

FIG. 4 is an exemplary flowchart illustrating a process for determining a first emergency level of an emergency management request according to some embodiments of the present disclosure. As shown in FIG. 4, process 400 includes the following steps. In some embodiments, the process 400 may be performed by the data center.

Step 410, determining a retrieval frequency of a piece of emergency management data based on historical retrieval data corresponding to the piece of emergency management data.

The historical retrieval data refers to data related to a history of retrievals corresponding to emergency management data over a past period. The past period may be a historical month, or the like. The historical retrieval data includes a historical retrieval time, a historical retrieval sequence, or the like, for each retrieval.

The retrieval frequency refers to a historical retrieval count per unit time for a piece of emergency management data. The unit time may be one day, one week, or the like.

In some embodiments, for each piece of emergency management data, the data center may determine the historical retrieval count of the piece of emergency management data based on the historical retrieval time for each retrieval of the piece of emergency management data in the historical retrieval data. The data center may then determine the historical retrieval count per unit time for the piece of emergency management data as the retrieval frequency of the piece of emergency management data.

Step 420, determining a second emergency level of the piece of emergency management data based on the retrieval frequency, a data type of the piece of emergency management data, and a geographic region to which the piece of emergency management data belongs.

In some embodiments, the data center may determine the second emergency level for each piece of emergency management data based on a vector database. The vector database includes feature vectors and labels corresponding to the feature vectors. The feature vector is constructed from a retrieval frequency, a data type, and a geographic region of each piece of historical emergency management data in a plurality of historical retrievals. The label corresponding to the feature vector refers to the second emergency level of the piece of historical emergency management data.

The label corresponding to the feature vector may be determined by: obtaining actual retrieval sequences for the piece of historical emergency management data corresponding to the feature vector during the plurality of historical retrievals; determining an average of the actual retrieval sequences; and setting the average as the second emergency level of the piece of historical emergency management data.

The data center may determine a vector to be matched for a piece of current emergency management data based on the retrieval frequency, the data type of piece of current emergency management data, and the geographic region to which the piece of current emergency management data belongs; determine a feature vector in the vector database with the highest vector similarity to the vector to be matched as the target vector; and set a label of the target vector as the second emergency level corresponding to the piece of current emergency management data.

In some embodiments, the data center may determine the second emergency level of the piece of emergency management data based on the retrieval frequency, the data type, and the geographic region of the piece of emergency management data, based on an emergency model.

In some embodiments, the emergency model is a machine learning model. The emergency model is a Neural Network (NN) model.

The emergency model includes an association feature extraction layer and an emergency level prediction layer. The association feature extraction layer and the emergency level prediction layer may be trained separately or jointly.

An input of the association feature extraction layer includes the each piece of emergency management data, the data type of the piece of emergency management data, and the geographic region to which the piece of emergency management data belongs. An output of the association feature extraction layer includes association features for each piece of emergency management data.

The association feature includes a plurality of association data associated with the emergency management data. For example, when association data for emergency management data A includes emergency management data B and C, the association feature for emergency management data A is defined as emergency management data B and C.

In separate training, the association feature extraction layer is trained based on first training samples and first labels. The data center may obtain a plurality of pieces of historical emergency management data, a plurality of data types of the plurality of pieces of historical emergency management data, and a plurality of geographic regions to which the plurality of pieces of historical emergency management data belong, during each of the plurality of historical retrievals, to construct a plurality of first training samples. The first label is an association feature corresponding to the plurality of pieces of historical emergency management data corresponding to the first training sample.

The data center may obtain a plurality of historical retrievals occurring after and before a historical retrieval corresponding to the piece of historical emergency management data in a first training sample. If a portion of historical emergency management data meets either condition: being retrieved in the same historical retrieval, or a retrieved count in adjacent historical retrievals exceeding a second preset threshold, then the portion of historical emergency management data constitutes mutually association data.

An input of the emergency level prediction layer includes the retrieval frequency, the association features, the data type, and the geographic region of the each piece of emergency management data. An output of the emergency level prediction layer includes the second emergency level of the each piece of emergency management data.

In separate training, the emergency level prediction layer is trained based on second training samples and second labels. The data center may obtain a plurality of historical retrievals corresponding to emergency management requests with incident losses below a preset threshold. The data center may use retrieval frequencies, association features, data types, and geographic regions of the plurality of pieces of historical emergency management data in each such historical retrieval to construct the second training samples. In some embodiments, the data center or other associated equipment may obtain losses resulting from incidents corresponding to the historical retrievals as the incident losses associated with the historical retrievals. The preset threshold is set on requirements. The second label is the second emergency level of the historical emergency management data in the second training sample. The data center may use the actual retrieval sequence of the historical emergency management data in the historical retrieval corresponding to the second training sample as the label of the second training sample.

A training process of the association feature extraction layer and the emergency level prediction layer trained separately is similar to a training process of the preset processing model in step 320 and is therefore not reiterated herein.

By introducing the retrieval frequency and the association features of the emergency management data into the emergency model, the emergency model enables consideration of future retrieval scenarios while predicting current data, thereby improving prediction accuracy.

Step 430, determining the first emergency level of the emergency management request based on the plurality of second emergency levels of the plurality of pieces of emergency management data corresponding to the emergency management request.

In some embodiments, the data center may obtain a weighted sum of the second emergency levels of the plurality of pieces of emergency management data corresponding to the emergency management request, and designate the weighted sum as the first emergency level of the emergency management request. A weighting coefficient of the second emergency level of the each piece of emergency management data is set based on experience.

In some embodiments, the data center determines a requirement overlap rate of the each piece of emergency management data of the plurality of pieces of emergency management data based on the plurality of pieces of emergency management data corresponding to the emergency management request, and, adjusts the plurality of first emergency levels of the plurality of emergency management requests based on the requirement overlap rate.

The requirement overlap rate refers to a retrieval coincidence rate of the piece of emergency management data across a plurality of emergency management requests.

In some embodiments, the data center receives a plurality of emergency management requests during a time period. The duration of the time period may be set based on requirements. The plurality of pieces of emergency management data of the emergency management requests may be processed as one batch. The data center may determine the requirement overlap rate of the emergency management data retrieved in the batch. In some embodiments, for the each piece of emergency management data, a ratio of a count of the emergency management requests that retrieved the piece of emergency management data to the total count of the emergency management requests in the batch is determined as the requirement overlap rate of the piece of emergency management data.

In some embodiments, for each emergency management request, the data center may determine an average of the requirement overlap rates of the plurality of pieces of emergency management data corresponding to the emergency management request, and multiply the first emergency level by the average to obtain an adjusted first emergency level of the emergency management request.

When determining the first emergency level of the emergency management request, considering the requirement overlap rate of the corresponding emergency management data enables prioritized retrieval of the emergency management data with a higher requirement overlap rate, thereby improving overall response speed for the batch.

Determining the second emergency level of the emergency management data based on the data type and the geographic region to which the emergency management data belongs enables prioritization of hazardous or important data in critical or high-risk regions.

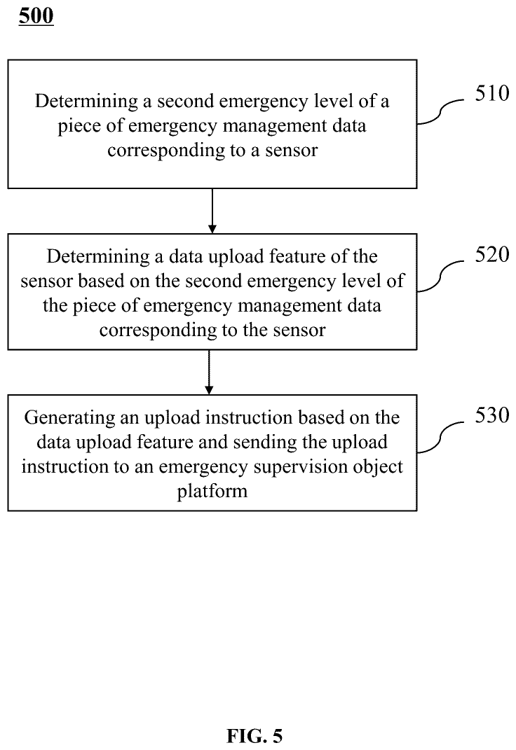

FIG. 5 is an exemplary flowchart illustrating a process for controlling sensors in a geographic region to upload data according to a data upload feature according to some embodiments of the present disclosure. As shown in FIG. 5, process 500 includes the following steps. In some embodiments, the process 500 may be performed by the emergency supervision management platform.

Step 510, determining a second emergency level of a piece of emergency management data corresponding to a sensor.

In some embodiments, the emergency management data includes a unique identification number of the sensor. The emergency supervision management platform may determine the emergency management data of the sensor based on the unique identification number of the sensor included in the emergency management data, and then obtain the second emergency level of the emergency management data from the data center. For relevant descriptions regarding obtaining the second emergency level of the emergency management data, please refer to related descriptions in step 230.

Step 520, determining a data upload feature of the sensor based on the second emergency level of the piece of emergency management data corresponding to the sensor.

The data upload feature includes a data upload volume and/or a data upload frequency. In some embodiments, the collection parameters further include the data upload feature of the sensor in the geographic region. For relevant descriptions regarding the collection parameters, please refer to related descriptions in step 240.

The data upload volume refers to an amount of data uploaded by the sensor per upload. The data upload volume may be in bytes.

The data upload frequency refers to a count of data uploads performed by the sensor per unit time.

In some embodiments, the emergency supervision management platform determines an average of the second emergency level(s) of one or more pieces of emergency management data corresponding to the sensor, and determines, based on the average, the data upload volume and the data upload frequency using a third preset table. The third preset table includes data upload volumes and data upload frequencies corresponding to different emergency management data, the average of the second emergency level(s) of which falls within different ranges of the second emergency level. In some embodiments, the third preset table is pre-set by a technician based on experience.

In some embodiments, the data center may adjust the data upload feature of the sensor based on an average requirement overlap rate of emergency management data corresponding to the sensor over a plurality of data retrievals during a preset period.

The average requirement overlap rate refers to an average of the requirement overlap rates of a plurality of pieces of emergency management data. For relevant descriptions regarding the requirement overlap rate, please refer to related descriptions in step 430.

In some embodiments, when the average requirement overlap rate of the plurality of pieces of emergency management data corresponding to the sensor exceeds a preset threshold, the data center adjusts the data upload frequency and the data upload frequency of the sensor by increasing the data upload frequency and the data upload frequency by a corresponding preset adjustment. The preset threshold and the preset adjustment are set by a technician based on experience.

In some embodiments, the preset adjustment correlates with one or more association features of the emergency management data corresponding to the sensor. The more association data that exist between the one or more pieces of emergency management data and other pieces of emergency management data, the greater the preset adjustment. The more association relationships between the one or more pieces of emergency management data and the other pieces of emergency management data are, the greater the impact of collection accuracy, collection volume, and collection frequency on the emergency management of the sensor, necessitating increasing the preset adjustment to ensure sufficient collection accuracy and volume.

Adjusting the data upload feature of the sensor based on the average requirement overlap rate of the corresponding emergency management data can allow a critical sensor (i.e., the sensor significantly impacting the emergency management) to achieve sufficient collection frequency and volume, thereby improving the timeliness and accuracy of emergency management.

Step 530, generating an upload instruction based on the data upload feature and sending the upload instruction to an emergency supervision object platform.

The upload instruction is configured to control the sensor in the geographic region upload data according to the data upload feature.

In some embodiments, after the emergency supervision object platform receives the upload instruction, the emergency supervision object platform sends the upload instruction to the sensor, controls the sensor to upload data according to the data upload feature to the emergency supervision object platform, and then sends the data to the emergency supervision management platform, for example, the database of the emergency supervision management platform.

Determining the data upload volume of the sensor based on the second emergency level of the emergency management data can achieve the critical sensor (i.e., the sensor significantly impacting the emergency management) to achieve sufficient collection frequency and volume, thereby improving the timeliness and accuracy of emergency management.

Having thus described the basic concepts, it may be rather apparent to those skilled in the art after reading this detailed disclosure that the foregoing detailed disclosure is intended to be presented by way of example only and is not limiting. While not expressly stated herein, a person skilled in the art may make a plurality of various alterations, improvements, and modifications that may occur and are intended to those skilled in the art, though not expressly stated herein. Such modifications, improvements, and amendments are suggested in this disclosure, so these alterations, improvements, and modifications are intended to be suggested by this disclosure and are within the spirit and scope of the exemplary embodiments of this disclosure.

In closing, it is to be understood that the embodiments of the present disclosure disclosed herein are illustrative of the principles of the embodiments of the present disclosure. Other modifications that may be employed may be within the scope of the present disclosure. Thus, merely by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for smart city emergency supervision based on an Internet of Things (IoT) large model, wherein the method is executed by an emergency supervision management platform, and
the method comprises:
in response to receiving an emergency management request from a sub-platform, determining a data retrieval prioritization for the emergency management request based on a first emergency level of the emergency management request;
retrieving emergency management data corresponding to the emergency management request from a database based on the data retrieval prioritization, including:
retrieving a plurality of pieces of emergency management data corresponding to the emergency management request;
retrieving, based on the plurality of pieces of emergency management data and a second emergency level of each piece of emergency management data of the plurality of pieces of emergency management data, a preset processing model corresponding to the each piece of emergency management data from a data processing model library, wherein the preset processing model is a machine learning model;
processing the each piece of emergency management data using a corresponding preset processing model to generate processed emergency management data; and
sending the processed emergency management data to the sub-platform;
within a preset period:
obtaining a plurality of second emergency levels of a plurality of pieces of emergency management data across a plurality of geographic regions from a previous preset period;
for each geographic region of the plurality of geographic regions:
determining collection parameters for different pieces of emergency management data within the geographic region based on the plurality of second emergency levels, the collection parameters including at least one of a patrol time or a patrol frequency of an emergency vehicle for the different pieces of emergency management data, and at least one of a shooting angle or a shooting frequency of a camera disposed on the emergency vehicle at a patrol point;
generating a patrol instruction based on the collection parameters and sending the patrol instruction to an emergency supervision object platform to control the emergency vehicle located in the geographic region to patrol within the geographic region according to at least one of the patrol time or the patrol frequency, and to control the camera at the patrol point to capture images according to at least one of the shooting angle or the shooting frequency to acquire a corresponding piece of emergency management data;
during a patrol by the emergency vehicle, controlling a built-in terminal in the emergency vehicle to detect an image captured at the patrol point; and
receiving a warning instruction returned by the built-in terminal and displaying the warning instruction on a display device.

2. The method according to claim 1, further comprising:
performing an incremental training on a plurality of preset processing models in the data processing model library based on emergency management data retrieved during the preset period, wherein a training sequence for the plurality of preset processing models is determined based on a plurality of emergency management requests corresponding to the plurality of preset processing models during the preset period.

3. The method according to claim 1, further comprising:
determining a retrieval frequency of the piece of emergency management data based on historical retrieval data corresponding to the piece of emergency management data;
determining the second emergency level of the piece of emergency management data based on the retrieval frequency, a data type of the piece of emergency management data, and a geographic region to which the piece of emergency management data belongs; and
determining the first emergency level of the emergency management request based on the plurality of second emergency levels of the plurality of pieces of emergency management data corresponding to the emergency management request.

4. The method according to claim 3, further comprising:
determining a requirement overlap rate of the each piece of emergency management data of the plurality of pieces of emergency management data based on the plurality of pieces of emergency management data corresponding to the emergency management request; and
adjusting a plurality of first emergency levels of a plurality of emergency management requests based on the requirement overlap rate.

5. The method according to claim 3, wherein the determining the second emergency level of the piece of emergency management data based on the retrieval frequency, a data type of the piece of emergency management data, and a geographic region to which the piece of emergency management data belongs includes:
determining the second emergency level of the piece of emergency management data, based on the retrieval frequency, the data type, and the geographic region of the piece of emergency management data, using an emergency model, the emergency model being a machine learning model.

6. The method according to claim 1, wherein:
the collection parameters include a data upload feature of a sensor within the geographic region, the data upload feature including at least one of a data upload volume or a data upload frequency; and
the method further comprises:
during the preset period:
determining the second emergency level of the piece of emergency management data corresponding to the sensor;
determining the data upload feature of the sensor based on the second emergency level of the piece of emergency management data corresponding to the sensor; and
generating an upload instruction based on the data upload feature and sending the upload instruction to the emergency supervision object platform to control the sensor in the geographic region upload data according to the data upload feature.

7. The method according to claim 6, further comprising:
adjusting the data upload feature of the sensor based on an average requirement overlap rate of emergency management data corresponding to the sensor over a plurality of data retrievals during the preset period.

8. A system for smart city emergency supervision based on an Internet of Things (IoT) large model, comprising: an emergency supervision management platform, an emergency supervision sensing network platform, and an emergency supervision object platform, wherein
the emergency supervision management platform is communicatively connected to the emergency supervision object platform via the emergency supervision sensing network platform;
the emergency supervision management platform includes sub-platforms and a data center, wherein the sub-platforms include at least one of an emergency prevention sub-platform, an emergency monitoring sub-platform, a risk prevention sub-platform, and an emergency response sub-platform;
the data center includes a database, a data processing model library, and a computing unit; and
the emergency supervision management platform is configured to execute the method for smart city emergency supervision based on the IoT large model in claim 1.

9. The system according to claim 8, wherein the data center is further configured to:
perform an incremental training on a plurality of preset processing models in the data processing model library based on emergency management data retrieved during the preset period, wherein a training sequence for the plurality of preset processing models is determined based on a plurality of emergency management requests corresponding to the plurality of preset processing models during the preset period.

10. The system according to claim 8, wherein the data center is further configured to:
determine a retrieval frequency of the piece of emergency management data based on historical retrieval data corresponding to the piece of emergency management data;
determine the second emergency level of the piece of emergency management data based on the retrieval frequency, a data type of the piece of emergency management data, and a geographic region to which the piece of emergency management data belongs; and
determine the first emergency level of the emergency management request based on the plurality of second emergency levels of the plurality of pieces of emergency management data corresponding to the emergency management request.

11. The system according to claim 10, wherein the data center is further configured to:
determine a requirement overlap rate of the each piece of emergency management data of the plurality of pieces of emergency management data based on the plurality of pieces of emergency management data corresponding to the emergency management request; and
adjust a plurality of first emergency levels of a plurality of emergency management requests based on the requirement overlap rate.

12. The system according to claim 10, wherein the data center is further configured to:
determine the second emergency level of the piece of emergency management data, based on the retrieval frequency, the data type, and the geographic region of the piece of emergency management data, using an emergency model, the emergency model being a machine learning model.

13. The system according to claim 8, wherein
the collection parameters further include a data upload feature of a sensor within the geographic region, the data upload feature including at least one of a data upload volume or a data upload frequency;
the emergency supervision management platform is further configured to:
during the preset period:
determine the second emergency level of the piece of emergency management data corresponding to the sensor;
determine the data upload feature of the sensor based on the second emergency level of the piece of emergency management data corresponding to the sensor; and
generate an upload instruction based on the data upload feature and send the upload instruction to the emergency supervision object platform to control the sensor in the geographic region upload data according to the data upload feature.

14. The system according to claim 8, wherein the emergency supervision management platform is configured to:
adjust the data upload feature of the sensor based on an average requirement overlap rate of emergency management data corresponding to the sensor over a plurality of data retrievals during the preset period.

15. A non-transitory computer-readable storage medium, the storage medium storing computer instructions, wherein when a computer reads the computer instructions in the storage medium, the computer executes the method for smart city emergency supervision based on the IoT large model of claim 1.
